(19) United States
(12) Patent Application Publication
(10) Pub. No.: US 2019/0364348 A1
(43) Pub. Date: Nov. 28, 2019

(54) EARPHONE WITH SEALING PROCESS BETWEEN LEATHER SHEATH AND LOUDSPEAKER COVER WITH SOFT RUBBER RING

(71) Applicant: Innovation Sound Technology Co., Ltd., Shenzhen (CN)

(72) Inventors: Shun Ming Yuen, Shenzhen (CN); Wai Yin Mung, Shenzhen (CN); Ka Ming Wu, Shenzhen (CN)

(21) Appl. No.: 16/520,336

(22) Filed: Jul. 23, 2019

Related U.S. Application Data
(63) Continuation of application No. PCT/CN2018/102758, filed on Aug. 28, 2018.

(30) Foreign Application Priority Data
May 28, 2018 (CN) 201820797859.3

(51) Int. Cl. H04R 1/00

(52) U.S. Cl. CPC H04R 1/00

(57) ABSTRACT

The present invention discloses an earphone with sealing process between a leather sheath and a loudspeaker cover with a soft rubber ring, comprising a leather sheath bracket. A soft rubber ring is arranged between the leather sheath bracket and a loudspeaker cover. A loudspeaker is fixed to an upper part of the loudspeaker cover. During assembly, the leather sheath is simply pressed and buckled towards the direction of the loudspeaker cover; and the soft rubber ring is clamped to deform to seal the matching between the leather sheath bracket and the loudspeaker cover, so that the sound from the loudspeaker in the earphone does not leak from a side surface. The method is stable in the sealing effect for a long time, has no risk of air leakage, is simple in operation, saves production and assembly man-hours, is easy in rework and repair and has no material scrapping.

### CROSS REFERENCE TO RELATED APPLICATIONS

The present application is a Continuation Application of PCT Application No. PCT/CN2018/102758 filed on Aug. 28, 2018, which claims the benefit of Chinese Patent Application No. 201820797859.3 filed on May 28, 2018. All the above are hereby incorporated by reference.

### TECHNICAL FIELD

The present invention relates to an earphone with sealing process between a leather sheath and a loudspeaker cover with a soft rubber ring, and belongs to the technical field of earphones.

### BACKGROUND

To output high quality audio for a headset, an earmuff and a loudspeaker cover must be completely sealed; otherwise, the sound will leak from a side surface. At present, most of headsets are assembled by applying double-sided adhesive on an earmuff back and then attaching the earmuff to the loudspeaker cover of the headset at one time. This design leads to the instability of seal of the headset. The headset must be tested and then repeatedly pressed to maintain the fit. As the storage time goes, it is easy to rebound to cause a risk of unsealing. At the same time, it is not easy to rework and repair after the fit, and it is easy to scrap the materials. Users cannot replace the earmuff; the cleaning of the headset is affected; and the assembly and production efficiency of the headset is also affected.

### SUMMARY

The technical problem to be solved by the present invention is to overcome the existing defects, to provide an earphone with sealing process between a leather sheath and a loudspeaker cover with a soft rubber ring. A leather sheath sleeve is fixed to a leather sheath bracket, and a sponge is filled inside the leather sheath bracket to form a complete earphone leather sheath. When the earphone works, a good sealing effect is needed between the leather sheath composed of the leather sheath bracket, the leather sheath sleeve and the sponge, and the loudspeaker cover. At present, products on the market are sealed by using glue or double-sided tape. The sealing effect of this method is unstable and will age with time, and the production efficiency is low. The present invention places a soft rubber ring between the leather sheath bracket and the loudspeaker cover, and adopts reverse buckle design between the leather sheath bracket and the loudspeaker cover. During assembly, the leather sheath is simply pressed and buckled towards the direction of the loudspeaker cover; and the soft rubber ring is clamped to deform to seal the matching between the leather sheath bracket and the loudspeaker cover, so that the sound from the loudspeaker in the earphone does not leak from a side surface. The method is stable without change in the sealing effect for a long time, has no risk of air leakage, is simple in operation, saves production and assembly man-hours, is easy in rework and repair and has no material scrapping, thereby effectively solving the problems in the background.

To solve the above technical problems, the present invention provides the following technical solution:

The present invention provides an earphone with sealing process between a leather sheath and a loudspeaker cover with a soft rubber ring, comprising a leather sheath bracket. A soft rubber ring is arranged between the leather sheath bracket and a loudspeaker cover. The leather sheath bracket and the loudspeaker cover are connected in a reverse buckle manner. A loudspeaker is fixed to an upper part of the loudspeaker cover.

As a preferred technical solution of the present invention, the soft rubber ring is used for sealing a gap between the leather sheath bracket and the loudspeaker cover.

As a preferred technical solution of the present invention, the earphone also comprises a sponge; and the sponge is filled inside the leather sheath bracket.

As a preferred technical solution of the present invention, the earphone also comprises a leather sheath sleeve; and the leather sheath sleeve is fixed to the leather sheath bracket.

The present invention achieves the beneficial effects: the present invention provides an earphone with sealing process between a leather sheath and a loudspeaker cover with a soft rubber ring. A leather sheath sleeve is fixed to a leather sheath bracket, and a sponge is filled inside the leather sheath bracket to form a complete earphone leather sheath. When the earphone works, a good sealing effect is needed between the leather sheath composed of the leather sheath bracket, the leather sheath sleeve and the sponge, and the loudspeaker cover. At present, products on the market are sealed by using glue or double-sided tape. The sealing effect of this method is unstable and will age with time, and the production efficiency is low. The present invention places the soft rubber ring between the leather sheath bracket and the loudspeaker cover, and adopts reverse buckle design between the leather sheath bracket and the loudspeaker cover. During assembly, the leather sheath is simply pressed and buckled towards the direction of the loudspeaker cover; and the soft rubber ring is clamped to deform to seal the matching between the leather sheath bracket and the loudspeaker cover, so that the sound from the loudspeaker in the earphone does not leak from a side surface. The method is stable without change in the sealing effect for a long time, has no risk of air leakage, is simple in operation, saves production and assembly man-hours, is easy in rework and repair and has no material scrapping.

### DESCRIPTION OF DRAWINGS

The drawings are used to provide further understanding for the present invention and constitute part of the description. The drawings are used to explain the present invention together with the embodiments of the present invention, and do not constitute a limitation to the present invention.

In the figures:

FIG. 1 is a schematic diagram of an integral structure of an earphone with sealing process between a leather sheath and a loudspeaker cover with a soft rubber ring in embodiments of the present invention.

FIG. 2 is a schematic diagram of an internal structure of an earphone with sealing process between a leather sheath and a loudspeaker cover with a soft rubber ring in embodiments of the present invention.

Numerals in the figures: 1 leather sheath bracket; 2 loudspeaker cover; 3 soft rubber ring; 4 leather sheath sleeve; 5 sponge; and 6 loudspeaker.

### DETAILED DESCRIPTION

The preferred embodiment of the present invention will be described below in combination with the drawings. It should be understood that the preferred embodiment described herein is only used for describing and explaining the present invention, but is not used for limiting the present invention.

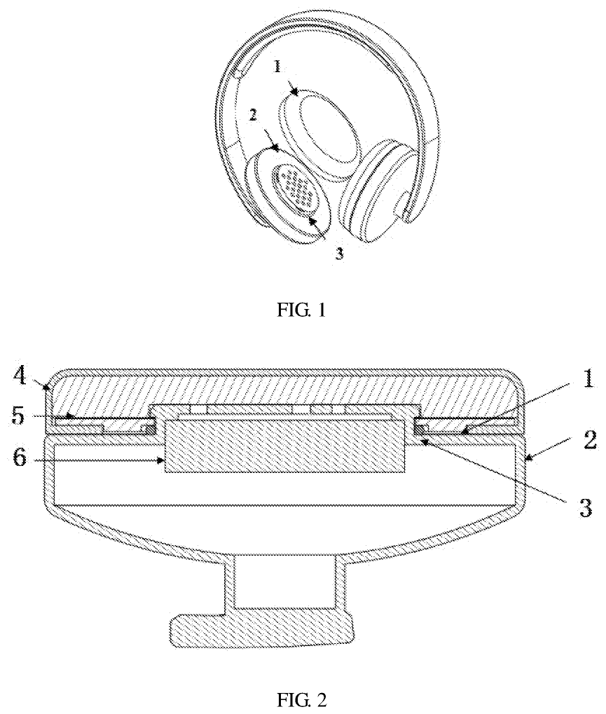

Embodiment: with reference to FIGS. 1-2, the present invention provides an earphone with sealing process between a leather sheath and a loudspeaker cover with a soft rubber ring, comprising a leather sheath bracket 1. A soft rubber ring 3 is arranged between the leather sheath bracket 1 and a loudspeaker cover 2. The leather sheath bracket 1 and the loudspeaker cover 2 are connected in a reverse buckle manner. A loudspeaker 6 is fixed to an upper part of the loudspeaker cover 2. The soft rubber ring 3 is used for sealing the gap between the leather sheath bracket 1 and the loudspeaker cover 2. The earphone also comprises a sponge 5. The sponge 5 is filled inside the leather sheath bracket 1. The earphone also comprises a leather sheath sleeve 4. The leather sheath sleeve 4 is fixed to the leather sheath bracket 1.

It should be noted that, the present invention provides an earphone with sealing process between a leather sheath and a loudspeaker cover with a soft rubber ring. During work, the leather sheath sleeve 4 is fixed to the leather sheath bracket 1, and the sponge 5 is filled inside the leather sheath bracket 1 to form a complete earphone leather sheath. When the earphone works, a good sealing effect is needed between the leather sheath composed of the leather sheath bracket 1, the leather sheath sleeve 4 and the sponge 5, and the loudspeaker cover 2. At present, products on the market are sealed by using glue or double-sided tape. The sealing effect of this method is unstable and will age with time, and the production efficiency is low. The present invention places the soft rubber ring 3 between the leather sheath bracket 1 and the loudspeaker cover 2, and adopts reverse buckle design between the leather sheath bracket 1 and the loudspeaker cover 2. During assembly, the leather sheath is simply pressed and buckled towards the direction of the loudspeaker cover 2; and the soft rubber ring 3 is clamped to deform to seal the matching between the leather sheath bracket 1 and the loudspeaker cover 2, so that the sound from the loudspeaker 6 in the earphone does not leak from a side surface. The method is stable without change in the sealing effect for a long time, has no risk of air leakage, is simple in operation, saves production and assembly man-hours, is easy in rework and repair and has no material scrapping.

Finally, it should be noted that the above description is only a preferred embodiment of the present invention, and is not intended to limit the present invention. Although the present invention is described in detail with reference to the above embodiment, those skilled in the art may still modify the technical solution recorded in the above embodiment, or equivalently replace some of the technical features. Any modification, equivalent replacement, improvement, etc. made within the spirit and the principle of the present invention shall be included within the protection scope of the present invention.

What is claimed is:

1. An earphone with sealing process between a leather sheath and a loudspeaker cover with a soft rubber ring, characterized by comprising a leather sheath bracket (1); a soft rubber ring (3) is arranged between the leather sheath bracket (1) and a loudspeaker cover (2); the leather sheath bracket (1) and the loudspeaker cover (2) are connected in a reverse buckle manner; and a loudspeaker (6) is fixed to an upper part of the loudspeaker cover (2).

2. The earphone with sealing process between a leather sheath and a loudspeaker cover with a soft rubber ring according to claim 1, characterized in that the soft rubber ring (3) is used for sealing a gap between the leather sheath bracket (1) and the loudspeaker cover (2).

3. The earphone with sealing process between a leather sheath and a loudspeaker cover with a soft rubber ring according to claim 1, characterized in that the earphone also comprises a sponge (5); and the sponge (5) is filled inside the leather sheath bracket (1).

4. The earphone with sealing process between a leather sheath and a loudspeaker cover with a soft rubber ring according to claim 1, characterized in that the earphone also comprises a leather sheath sleeve (4); and the leather sheath sleeve (4) is fixed to the leather sheath bracket (1).

5. The earphone with sealing process between a leather sheath and a loudspeaker cover with a soft rubber ring according to claim 2, characterized in that the earphone also comprises a leather sheath sleeve (4); and the leather sheath sleeve (4) is fixed to the leather sheath bracket (1).

6. The earphone with sealing process between a leather sheath and a loudspeaker cover with a soft rubber ring according to claim 3, characterized in that the earphone also comprises a leather sheath sleeve (4); and the leather sheath sleeve (4) is fixed to the leather sheath bracket (1).
